(19) United States
(12) Patent Application Publication
(10) Pub. No.: US 2026/0070141 A1
(43) Pub. Date: Mar. 12, 2026

(54) SOLDERING DEVICE, AND METHOD FOR SOLDERING

(71) Applicant: Liebherr-Aerospace Lindenberg GmbH, Lindenberg (DE)

(72) Inventors: Martin DÖHRING, Lindenberg (DE); Daniel ZIMMERMANN, Wangen (DE)

(21) Appl. No.: 19/325,281

(22) Filed: Sep. 10, 2025

(30) Foreign Application Priority Data
Sep. 12, 2024 (DE) 10 2024 126 272.9

(51) Int. Cl. B23K 3/08; B23K 3/047; B23K 37/04

(52) U.S. Cl. CPC B23K 3/087; B23K 3/0475; B23K 37/0426

(57) ABSTRACT

The disclosure relates to a soldering device for soldering components, and comprises a linear unit that is configured for moving a component placed thereon back and forth along one direction, an optical measuring unit comprising a detection region directed onto a portion of the linear unit in order to measure a component placed on the linear unit, and a soldering unit which is configured for soldering a first constituent of the component, preferably a sphere, to a second constituent of the component, preferably a wire.

### CROSS REFERENCE TO RELATED APPLICATION

The present application claims priority to German Patent Application No. 10 2024 126 272.9 filed on Sep. 12, 2024. The entire contents of the above-listed application are hereby incorporated by reference for all purposes.

### TECHNICAL FIELD

The present disclosure relates to a soldering method and a device for soldering.

### BACKGROUND

In modern manufacturing technology, precision and reliability are of decisive importance, in particular in safety-critical applications such as air travel. Soldering methods play an important role in the manufacture of components as are used in electrohydraulic servo valves (EHSV). These valves are typically used for controlling air-guiding surfaces in aircraft, where high precision and reliability are essential.

According to the prior art, the individual constituents of a soldering assembly are inserted manually into a soldering device. In this case, no monitoring of the correct position and correctness of the constituents relative to one another takes place, which can lead to a high error rate. Before the start of the soldering procedure, a low-oxygen atmosphere must be created, which results in a high consumption of protective gases. The heating of the component then takes place, up to a predetermined temperature, in order to perform the soldering process. After termination of the soldering process, the component must cool, which also takes time. The entire soldering process is accompanied by a staff member, who must subsequently perform a check of the soldering results.

This approach has several disadvantages, such as the individual manufacture, the long waiting time per component, the high consumption of protective gas, and the lack of an automated process and result control. This not only impairs the efficiency of the production process, but rather a high scrap rate also results, which increases the production costs and negatively influences the quality of the end products.

The present disclosure aims to solve these problems and to allow for a more process-reliable, efficient and fully automated soldering method which adheres to the positioning and dimensional tolerances and minimizes the consumption of consumable media.

The aim of the present disclosure is to provide a soldering device and a method for soldering, which overcomes or at least reduces the disadvantages of the prior art set out above. This is achieved by a device and a method as described herein.

The soldering device according to the disclosure for soldering components comprises a linear unit that is configured for moving a component placed thereon back and forth along one direction, an optical measuring unit comprising a detection region directed onto a portion of the linear unit in order to measure a component placed on the linear unit, and a soldering unit which is configured for soldering a first constituent of the component, optionally a nozzle pipe, to a second constituent of the component, optionally a wire.

The novel soldering method allows for more process-reliable and automatic soldering of a component, in which a high degree of positioning and dimensional tolerance is adhered to with the aid of the optical measuring unit. The soldering device according to the disclosure allows for a fully automated procedure with integrated monitoring of the results.

Typically, in this case, the component to be soldered comprises a first constituent and a second constituent, which are to be interconnected. In general, in this case, the two constituents are metal in nature and are interconnected with the aid of a solder. This is achieved by heating the constituents to be interconnected to a temperature that is below the melting point of the constituents to be interconnected. A solder material, typically also a metal or a metal allow, arranged in the connection region of the two constituents has a lower melting point in comparison, such that heating of the typically also metal constituents causes the solder material to liquify and penetrate into gaps of the connection region, such that after cooling a connection of the two components to be soldered together has occurred.

In this case, it can be provided that the component, which consists of at least two constituents, is already arranged such that only heating of the component has to be performed, in order to carry out the soldering procedure. In other words, the arrangement of the plurality of constituents which are to be soldered together, and the solder material required for this, can thus already be at the correct position, such that the soldering procedure can be initiated by supplying thermal energy into the component.

According to an optional modification of the present disclosure, it can be provided that the soldering unit is a soldering inductor which heats the constituents, to be interconnected, of the component with the aid of induction.

A soldering inductor is a tool that uses electromagnetic induction in order to quickly and precisely heat the constituents of the component, as a result of which the solder melts and interconnects the constituents. In this case, the soldering inductor generates a high-frequency electromagnetic field which induces eddy currents in the metal constituents of the component and thus heats them without direct contact.

The contactless addition of thermal energy into the constituents, to be heated, of the component is also advantageous in this respect since an arrangement of the different constituents, once assumed, cannot be disturbed by the application of a force of a conventional soldering iron. Accordingly, a fixing of the components to be soldered can be designed to be less resistant than would be the case with a soldering unit that requires physical contact for heat transmission.

According to a further advantageous modification of the present disclosure, it can be provided that the soldering device further comprises a detection unit for determining a temperature and/or an atmosphere composition in the region of the component to be soldered.

The detection unit accordingly serves to determine the temperature and/or the composition of an atmosphere located in the region of the component, in order to be able to perform a soldering procedure in a reproducible manner. Thus, the determination of the temperature can prevent the occurrence of too great a heating of the constituents, to be joined together, of the component, which could possibly lead to damage. Furthermore, however, performing heating of the constituents that is below a predetermined threshold value and leads to insufficient liquifying of the solder, which results in a poorer connection, is also prevented.

Similar applies for the determination of the atmosphere which prevails around the component to be soldered. Here, too, with respect to reproducibility with consistently good results it is the case that a deviation in the atmosphere, in which a soldering procedure takes place, should be avoided as far as possible, since otherwise non-uniform reproducible soldering procedures occur. The detection of the prevailing atmosphere during soldering can also be consulted for a subsequent optimization step, which, depending on the obtained soldering results, allows for a conclusion on the best possible atmosphere for soldering the component. Of course, a corresponding evaluation with respect to the temperature is also covered by the disclosure.

According to a further advantageous modification of the present disclosure, this further comprises a shielding unit which surrounds the component prior to soldering of the component and serves to establish shielding with respect to an oxygen-rich surrounding atmosphere, in particular wherein the shielding unit is a glass tube.

In order to create an optimal atmosphere for the soldering, the shielding unit is provided, which surrounds the component to be soldered during the soldering procedure. In order to now expel the regular surrounding atmosphere, which, with its high oxygen content opposes an optimal soldering result, in the close vicinity of the soldering procedure, in general a protective medium is caused to flow into the interior of the shielding unit, in order to keep the regular surrounding atmosphere far from the solder joint.

The shielding unit, which can for example be made of glass and is in particular configured as a glass tube, accordingly serves as a separating medium between the regular surrounding atmosphere and a region in which the added protective medium prevails during a soldering procedure.

A positive effect of using the shielding unit is the reduction of consumable media, such as the protective medium, to a minimum.

According to a further optional modification of the present disclosure, it can be provided that an output unit for a protective medium, in particular for a flux or for a protective gas, for minimizing an oxidation that occurs during soldering is provided.

The oxygen present in the normal surrounding atmosphere impairs the quality of solder connections, in that it causes oxidation at the metal surfaces. These oxide layers prevent an effective wetting and flowability of the solder, which leads to poor and unreliable connections. Furthermore, oxidations can lead to porosity and other structural weaknesses in the solder joint, which impairs the mechanical and electrical integrity of the connection.

In this case, the protective medium can also be configured in gaseous form as a protective gas, and comprise for example argon or nitrogen or consist of these constituents, in order to protect the solder joint from oxygen.

According to a further optional modification of the present disclosure, it can be provided that the output unit interacts with the shielding unit such that the protective medium surrounds/flows around the component surrounded by the shielding unit, in order that a soldering procedure can be carried out within the protective medium in a protective atmosphere thus created. As already set out above, this primarily applies for protecting the solder joint from oxygen, which is disadvantageous for the solder connection.

According to a further advantageous development of the present disclosure, it can be provided that the soldering unit has a U-shaped recess in which the component to be soldered is to be arranged during a soldering procedure.

In particular when the soldering unit is configured as a soldering inductor, it is expedient to bring the shielding unit into the immediate vicinity of the connection point of the component that is to be soldered, such that the soldering unit generates heating of the component through the shielding unit. In other words, the shielding unit is arranged between the connection point, to be soldered, of the component, and the soldering unit, which advantageously leads to the amount of protective medium being significantly smaller compared with a protective atmosphere of larger dimensions. Finally, protective atmosphere has to be applied only to the interior of the shielding unit, in the immediate vicinity of the solder joint, to be connected, of the component, which leads to significant savings in the consumption of the protective medium.

According to an advantageous embodiment, it can furthermore be provided that the shielding unit surrounding the component to be soldered is arranged in the interior of the U-shaped recess of the soldering unit during a soldering procedure. In this case, the two limbs of the soldering unit are arranged on an outside of the shielding unit, whereas the point of the component to be soldered is located in the interior of the shielding unit, such that a straight connection from the solder joint to a limb of the soldering unit crosses the shielding unit.

According to a further advantageous modification of the present disclosure, it can be provided that the soldering unit is configured for performing the soldering the component in the detection region of the optical measuring unit.

It is not only possible to place the component in the detection region before the soldering procedure starts, such that it is already possible to determine in advance, with the aid of a measurement of the optical measuring unit, whether the individual constituents of the component are arranged correctly relative to one another, but rather a measurement can also be performed after the soldering procedure, in order to check the correct result of the soldering. In this case, it is advantageous if the soldering procedure is already completed in the detection region of the optical measuring unit, since after the soldering procedure has been concluded there is then no need for any movement of the linear unit for transferring the soldered component into a detection region. The procedure for carrying out the soldering, and a verification of the soldering result, is accordingly quicker.

According to a further optional development of the present disclosure, it can be provided that a fixing is provided that fixes the constituents, to be soldered, of the component, optionally wherein a solder is also already arranged at a connection point of the constituents to be soldered.

According thereto, the individual constituents of the component are aligned in a fixing relative to one another, wherein advantageously the solder can also already be applied to the connection point, and then placed on the linear unit. The linear unit is then capable of transferring the fixed component into a detection region, in order to check whether the individual constituents are also actually correctly aligned relative to one another. If this is the case, the component is soldered with the aid of the soldering unit, such that the two constituents are rigidly interconnected. Subsequently, it is possible to verify, with the aid of the optical measuring unit, whether the soldering procedure has produced the desired result.

According to a further advantageous modification of the present disclosure, it can be provided that, for placing at least one component on the linear unit, a parts carrier is provided, which is releasably coupled to the linear unit.

For quickly soldering a plurality of components, it is expedient to use a parts carrier that supports at least one component, advantageously a plurality of components to be soldered. Thus, fixing of the individual constituents of the component can already be carried out in a preparation step, and the fixed component can be inserted in a specific parts carrier, such that when a soldering procedure is to be performed, the parts carrier containing the plurality of components can be placed on the linear unit. The linear unit then accordingly displaces the parts carrier or the components arranged in the parts carrier, as described above, and ensues that the at least one component is soldered. If a plurality of components is present, the soldering procedure is carried out successively, in a stepwise manner, for each of the components arranged in the parts carrier.

The disclosure additionally relates to a method for soldering components, in particular with a soldering device, comprising the steps of:
placing a component on a linear unit, optionally wherein the component comprises a first constituent, such as a sphere nozzle pipe, and a second constituent, such as a wire,
measuring the component by an optical measuring unit, and checking the correctness and/or the dimensional accuracy of the component against predefined target values,
arranging a shielding unit for receiving the component and for shielding the component against a surrounding atmosphere,
placing the soldering unit for performing a soldering procedure on the component, in order to solder the first constituent of the component and the second constituent of the component,
outputting a protective medium into the interior of the shielding unit, in which the component to be soldered is arranged, in order to create a protective atmosphere in the shielding unit,
soldering the first component received by the soldering unit to the second component placed on the linear unit with the aid of the soldering unit, and
performing an optical dimension check of the soldered component by the optical measuring unit, and optionally
storing the measurement results obtained after the optical dimension check by the optical measuring unit in a file in order to carry out documentation.

The method according to the disclosure makes it possible for a fully automatic soldering process to be implemented, which can process a large quantity of components to be soldered, in a short time. Furthermore, the internal controls of the system, for example implemented with the aid of the optical measuring unit and the measuring steps performed thereby, ensures a process-reliable procedure, which checks the correct soldering of the component. Furthermore, providing the shielding unit, which is advantageously arranged between the limbs of a soldering inductor, significantly reduces the space for supplying a protective medium, and therefore the consumption of protective medium is reduced.

According to a development of the method according to the disclosure, it can be provided that the component is rejected on the basis of the measurement of the component and/or after performing the soldering procedure, or the following step is performed with the respective component.

The measurement of the component that is not yet soldered, by the optical measuring unit, or the measurement of the soldered component by the optical measuring unit, serves on the one hand to ensure the correct arrangement, relative to one another, of the individual constituents of the not yet soldered components, and on the other hand to check whether the desired soldering result also complies with the target specifications.

According to a further optional modification of the present disclosure, it can be provided that the protective atmosphere created in the shielding unit is monitored with the aid of the detection unit, and/or the temperature of the component, used during a soldering procedure, is monitored with the aid of a detection unit.

According to a further advantageous modification of the present disclosure, it can be provided that the movements performed by the linear unit for placing the component, a result of a measurement of the component before the soldering procedure, the composition of the protective atmosphere when performing the soldering procedure, the temperature of the component during the soldering procedure, and/or a result of a measurement of the component after the soldering procedure, are stored in order to optimize the method for soldering depending thereon, with the aid of an optimization algorithm which is optionally based on artificial intelligence.

The soldering procedure can thus be optimized on the basis of the acquired data, with the aid of an optimization algorithm, in that the individual acquired items of data are considered with respect to the desired soldering result, and deviations in the data which have led to an improvement of an impairment of the soldering result are analyzed and identified.

### BRIEF DESCRIPTION OF THE FIGURES

Further features, details and advantages of the disclosure are clear from the following description of the figures, in which:

FIG. 1: is a schematic perspective view of a soldering device according to the disclosure, and

FIG. 2A-FIG. 2B: schematically show an implementation of the method according to the disclosure.

### DETAILED DESCRIPTION

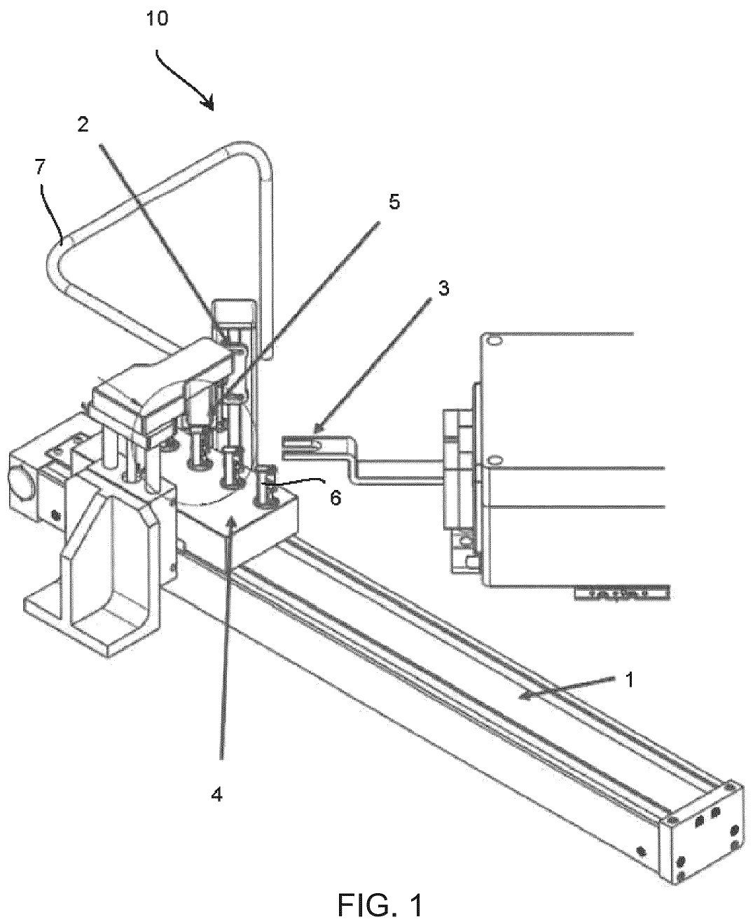

FIG. 1 is a schematic view of a soldering device 10 according to the present disclosure.

The linear unit 1 is visible, on which a plurality of components 6 is placed, in a parts carrier 4. In this case, the components 6 have a plurality of constituents which are to be soldered together and which can already be fixed in their alignment to be soldered and arranged in the parts carrier 4. In this case, required solder material can also already be arranged at the connection point of the constituents.

The linear unit 1 is capable of moving the plurality of components back and forth in one direction, wherein the displacement path of the linear unit 1 crosses a detection region of an optical measuring unit 2. The optical measuring unit 2 can now measure the component 6, placed in its detection region, exactly with respect to its dimensioning and its positioning relative to the soldering unit. In this case, the measurement of the component 6, assembled from a plurality of constituents, can also be used to check whether the individual constituents are correctly positioned relative to one another, such that it is very likely that the soldering procedure to be performed will achieve a satisfactory result.

Furthermore, the soldering device 10 according to the disclosure comprises a soldering unit 3, which is configured for soldering a component arranged on the linear unit 1. Typically, the soldering unit 3 is capable of performing a movement along a single movement axis, and therefore the correct positioning of the component 6 to be soldered, with the aid of the linear unit 1, is very important.

According to an advantageous embodiment of the soldering device 10, in this case the procedure of soldering also takes place within the detection region of the optical measuring unit 2, in order for example after soldering, in which the two components joined together have been soldered together, to perform a measurement of the soldered component, in order to find out whether the assembled component corresponds to the predetermined dimensioning specifications or exceeds acceptable tolerances. Thus, after a soldering procedure, it is possible to check relatively quickly, with the aid of the optical measuring unit 2, whether or not a desired result with respect to the accuracy of the arrangement of the individual constituents has been achieved.

Furthermore, a shielding unit 5 is visible, which serves to shield the region to be soldered of the two constituents of the component 6 from a surrounding atmosphere. By way of example, said shielding unit 5 can be made of glass, for example a glass tube or the like, and can constitute a barrier between an artificially created protective atmosphere, in which the soldering achieves better results, and the typically oxygen-containing surrounding atmosphere.

In this case, the reference sign 7 denotes an output unit for a protective medium, wherein the procedure of soldering takes place in an improved manner in the protective medium, compared with the surrounding atmosphere. Typically, the protective medium can also be configured as a protective gas, which can comprise argon and/or nitrogen or consist of these constituents, such that an introduction in the shielding unit for displacing the surrounding atmosphere is easy to implement.

The soldering unit 3 shown is implemented as a soldering inductor, in which the inductor tip consists of a planar element which has a U-shaped recess.

If the component to be soldered is brought, with its two constituents to be fastened together, into the U-shaped recess of the inductor tip, then heat is induced in the constituents, to be welded together, of the component 6 with the aid of an electromagnetic field. After reaching a temperature threshold, melting of the solder material then occurs, such that the two constituents are fixed to one another.

An advantage of the design in this case is that the shielding unit, for example a glass tube or the like, can also be introduced into the recess of the inductor tip, and therefore the protective medium is to be applied to only a very small space around the connection point of the two constituents. This significantly reduces the consumption of the protective medium, such that a significant cost saving can be achieved here.

A superordinate control unit, which is connected to the linear unit 1, the optical measuring unit 2 and the soldering unit 3 and stores the respective parameters of the different settings and actions of the soldering device 10 during soldering, is not shown. This information can be used subsequently to perform an optimization algorithm which aims to improve the soldering. In this case, the optimization algorithm can work with the aid of artificial intelligence and automatically perform an optimization of the settings and actions of the soldering device 10. In addition to the positioning of the component 6 carried out via the linear unit 1, in this case the temperature of the individual constituents during the soldering procedure, the results of the optical measuring unit which were obtained before and after a soldering procedure, and/or the composition of the protective medium during the soldering procedure can also be saved and used for an optimization or stored in a file for documentation purposes.

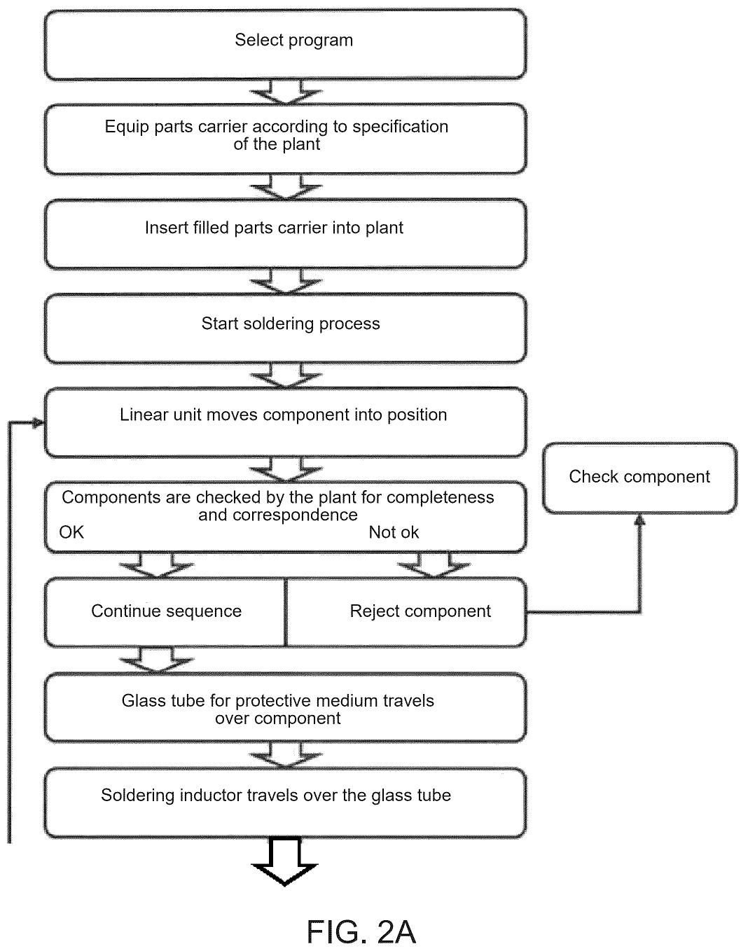

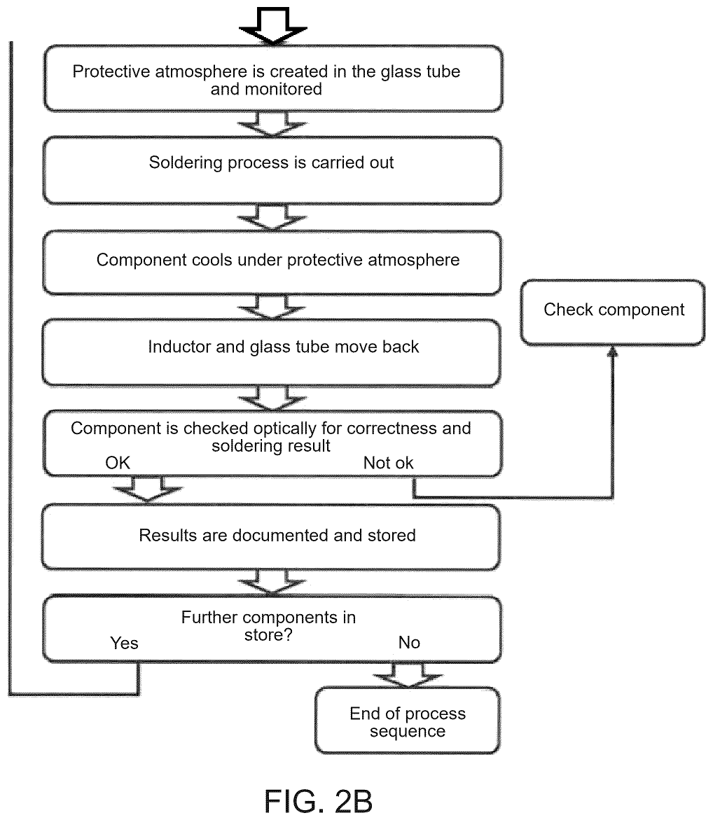

FIG. 2A-FIG. 2B show a flowchart of the method according to the disclosure for soldering, wherein the flowchart, on account of its size, has been divided over two different pages of drawings, FIG. 2A and FIG. 2B.

Firstly, a specific program for soldering two constituent parts of a component is selected, and a parts carrier 4 is equipped according to the specifications of the plant. In this case, in the further course of the method the parts carrier can interact with the linear unit, such that the linear unit is capable of shifting the components arranged in the parts carrier 4. Thus, if the parts carrier 4 has been filled and inserted into the plant, the machine that operates according to the method starts the soldering process.

Initially, the first component is moved to a predetermined position in which the optical measuring unit has its detection region.

In this case, in a first step, the linear unit 1 is actuated and displaces a component arranged thereon into the detection region of the optical measuring unit 2.

Then, the component, for example a nozzle pipe and a wire to be soldered thereto, is checked for correctness and dimensional accuracy with the aid of the optical measuring unit, such that it is possible to identify whether or not the component is within the predetermined tolerance limits. If this is not the case, this leads to rejection or checking of the component, such that subsequently an exchange and a manual check of the rejected component can take place. If, in contrast, the dimensional accuracy of the first component is correct, which also includes the arrangement position of the constituents relative to one another, the shielding unit is positioned such that it substantially receives the component to be soldered.

If the shielding unit, for example a glass tube, is brought into position, the soldering unit 3 is moved in position such that upon activation of the soldering unit the temperature in the constituents, to be soldered, of the component increases.

However, before the soldering unit is activated, a protective medium is introduced into the region defined by the shielding unit, with the aid of the output unit, in order to create a protective atmosphere in the region of the connection point, to be soldered, of the two constituents of the component, in which atmosphere a particularly effective soldering procedure can be performed.

Subsequently, the soldering process is performed in that the soldering unit is activated and causes a temperature increase in the constituents of the component, such that melting of the solder material arranged in the connection region occurs.

In this case, it is clear to a person skilled in the art that the solder material can already be applied in the connection region of the two constituents of the component in advance, wherein, however, the disclosure also covers the case where there is a device for outputting solder material which supplies the solder material to the connection point during the soldering procedure. Furthermore, in the equipping, a soldering ring can be provided in the connection region, for example pushed onto a wire, in order that the solder material is already in situ before the soldering procedure.

After the two constituents of the component have been soldered together, the component cools under the protective atmosphere. After cooling, the soldering unit moves back, wherein the soldering unit can also be moved back already during cooling or thereafter, such that a movement of the soldered component by the linear unit is then possible again.

Then, after cooling, the soldered component is checked optically, with the aid of the optical measuring unit 2, for dimensional accuracy and correctness of the soldering result, wherein the measurement can, in the case of a deviation of the acceptable tolerances, lead to the output of a signal, whereupon the component is for example manually checked or rejected.

If, in contrast, the measurement has been satisfactory, i.e. all the parameters are within acceptable tolerance values, documentation and storage of the results takes place. In this case, the results comprise different information and can for example include the timepoint of the soldering procedure, the temperature of the individual constituents during the soldering, the composition of the protective medium, the duration of the soldering procedure, the exact position of the soldering unit and of the component to be soldered, the measurement result of the optical measuring unit before the soldering and/or the measurement result of the optical measuring unit after the soldering.

The results or information thus obtained can also be used subsequently to optimize the soldering procedure. This can take place with the aid of an adjustment of the parameters during operation of the soldering device 10, with the aid of machine learning algorithms and/or artificial intelligence.

Furthermore, after documentation of the measurement results, the method checks whether further components are still present in the parts carrier, which have not yet been soldered together. If this is the case, the linear unit is moved such that the next component is moved into the detection region of the optical measuring unit 2, such that the soldering procedure can begin again from the start.

If, in contrast, it is found that no further components are arranged in the parts carrier 4, the method is ended.

### LIST OF REFERENCE SIGNS

1 linear unit
2 optical measuring unit
3 soldering unit
4 parts carrier
5 shielding unit
6 component
7 output unit of protective medium
10 soldering device

1. Soldering device for soldering components, comprising:
a linear unit which is configured for moving a component placed thereon back and forth along one direction,
an optical measuring unit comprising a detection region directed onto a portion of the linear unit, in order to measure a component placed on the linear unit, and
a soldering unit which is configured for soldering a first constituent of the component, to a second constituent of the component.

2. Soldering device according to claim 1, wherein the soldering unit is a soldering inductor which heats the constituents, to be interconnected, of the component with the aid of induction.

3. Soldering device according to claim 1, further comprising a detection unit for determining a temperature and/or an atmosphere composition in the region of the component to be soldered.

4. Soldering device according to claim 1, further comprising a shielding unit which surrounds the component prior to soldering of the component and serves to establish shielding with respect to an oxygen-rich surrounding atmosphere.

5. Soldering device according to claim 4, further comprising an output unit for a protective medium, for minimizing an oxidation that occurs during soldering.

6. Soldering device according to claim 5, wherein the output unit interacts with the shielding unit such that the protective medium surrounds/flows around the component surrounded by the shielding unit, in order that a soldering procedure can be carried out within the protective medium in a protective atmosphere thus created.

7. Soldering device according to claim 4, wherein the soldering unit has a U-shaped recess in which the component to be soldered is to be arranged during a soldering procedure.

8. Soldering device according to claim 7, wherein the shielding unit surrounding the component to be soldered is arranged in the interior of the U-shaped recess of the soldering unit during a soldering procedure.

9. Soldering device according to claim 1, wherein the soldering unit is configured to perform the soldering of the component in the detection region of the optical measuring unit.

10. Soldering device according to claim 1, wherein a fixing is provided that fixes the constituents, to be soldered, of the component.

11. Soldering device according to claim 1, wherein for placing at least one component on the linear unit a parts carrier is provided, which is releasably coupled to the linear unit.

12. Method for soldering components, with a soldering device according to claim 1, comprising the steps of:
placing the component on a linear unit,
measuring the component by an optical measuring unit and checking the correctness and/or the dimensional accuracy of the component against predefined target values,
arranging a shielding unit for receiving the component and for shielding the component against a surrounding atmosphere,
placing the soldering unit for performing a soldering procedure on the component, in order to solder the first constituent of the component and the second constituent of the component,
outputting a protective medium into the interior of the shielding unit, in which the component to be soldered is arranged, in order to create a protective atmosphere in the shielding unit,
soldering the first component received by the soldering unit to the second component placed on the linear unit, with the aid of the soldering unit,
performing an optical dimension check of the soldered component by the optical measuring unit, and
storing the measurement results obtained after the optical dimension check by the optical measuring unit in a file in order to carry out documentation.

13. Method according to claim 12, wherein the component is rejected on the basis of the measurement of the component and/or after performing the soldering procedure, or the following step is performed with the respective component.

14. Method according to claim 12, wherein the protective atmosphere created in the shielding unit is monitored with the aid of the detection unit, and/or the temperature of the component, increased during a soldering procedure, is monitored with the aid of a detection unit.

15. Method according to claim 12, wherein the movements performed by the linear unit for placing the component, the composition of the protective atmosphere when performing the soldering procedure, the temperature of the component during the soldering procedure, and/or a result of a measurement of the component after the soldering procedure, are stored in order to optimize the method for soldering depending thereon, with the aid of an optimization algorithm which is based on artificial intelligence.

16. Soldering device according to claim 1, wherein the first constituent of the component, is a nozzle pipe and the second constituent of the component is a wire.
